(19) United States
(12) Patent Application Publication
(10) Pub. No.: US 2010/0181962 A1
(43) Pub. Date: Jul. 22, 2010

(54) Nondirectional Radio Frequency Rechargeable Dry Cell

(76) Inventors: Shih Chung Chen, Hsin Chuang City (TW); Shu-Mu Chen, Sanchong City (TW)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 12/652,388

(22) Filed: Jan. 5, 2010

(30) Foreign Application Priority Data
Jan. 21, 2009 (CN) CN20090003987.7

(51) Int. Cl. H02J 7/00

(52) U.S. Cl. 320/108

(57) ABSTRACT

This invention relates to a nondirectional radio frequency (RF) rechargeable dry cell, including a dry cell case, an accumulator that installed inside the dry cell case, and a nondirectional radio frequency charge unit. The nondirectional radio frequency charge unit includes a nondirectional induction coil and charging control circuit, wherein the nondirectional induction coil connects with the accumulator by the charging control circuit. The nondirectional radio frequency rechargeable dry cell of this invention is able to carry on wireless charging for the dry cell by the induction of the high-frequency impulse magnetic field and converting into electrical energy, which is efficient and far ranged. When the electric appliance using the nondirectional radio frequency rechargeable dry cell of this invention, the wireless charging is realized without the removal of the batteries from the electric appliance, and is flexible and convenient.

### TECHNICAL FIELD

The invention relates to a rechargeable dry cell, especially refers to a nondirectional radio frequency rechargeable dry cell.

### BACKGROUND ART

Currently, the use of dry cell in the electrical appliances is very popular, and because most of the dry cells are non-rechargeable batteries, once they run out of power, they will be discarded, which resulting in great waste and causing serious environmental pollution, therefore the usage for the re-chargeable batteries are widely applied. However, the common re-chargeable dry cell is composed by the dry cell case and the accumulator that installed inside the dry cell case, in this way, the dry cell must be removed from the electrical appliance, so that the corresponding charger could implement for charging, which is quite inconvenient in use.

### CONTENTS OF THE INVENTION

This invention is to provide a nondirectional radio frequency rechargeable dry cell that is able to carry on wireless charging for the dry cell by the induction of the high-frequency impulse magnetic field and converting into electrical energy, which is efficient and far ranged.

For achieving the objective above, this invention adopts the following technical solution:

A nondirectional radio frequency rechargeable dry cell, including a dry cell case and an accumulator that installed inside the dry cell case, characterized in that it also includes a nondirectional radio frequency charge unit, wherein the nondirectional radio frequency charge unit includes a nondirectional induction coil and charging control circuit, wherein the nondirectional induction coil connects with the accumulator by the charging control circuit; the nondirectional induction coil including:

X axis coil, wherein the coil is winding along with the X axial direction of iron core, to induce the high-frequency impulse magnetic field from X axis and cut magnetic line to generate induced electric current in the coils;

Y axis coil, wherein the coil is winding along with the Y axial direction of iron core, to induce the high-frequency impulse magnetic field from Y axis and cut magnetic line to generate induced electric current in the coils;

Z axis coil, wherein the coil is winding along with the Z axial direction of iron core, to induce the high-frequency impulse magnetic field from Z axis and cut magnetic line to generate induced electric current in the coils;

The iron core, wherein the iron core has construction filament winding of which includes X, Y, and Z axial direction spatial stereo coordinates.

The foresaid dry cell case is composed by the upper cover and lower cover, wherein the upper cover and lower cover fixed joint by screw; the upward side of the upper cover has exerted copperhead, while the downward side of the lower cover has exerted sheet copper; between the copperhead and the sheet copper installs nondirectional induction coil, charging control circuit and accumulator with electrical connection by sequence.

The nondirectional induction coil of the invention integrated with the X, Y, Z axis coils, and installed in an iron core with high magnetic permeability, so that it could induce high-frequency impulse electromagnetic wave in every direction among the resonance range of the coil loops at the same time or respectively. The radio frequency rechargeable battery that composed by the nondirectional induction coil has high transmission distance for charging, and high transmission efficiency. Furthermore, the radio frequency rechargeable battery that composed by the nondirectional induction coil alters the original charging pattern that the battery must be in touch with the charges to achieve the charging, so the transmission distance for charging is further, and more convenient in charging. Moreover, by replace the traditional battery to the radio frequency rechargeable battery, the charging could be realized once the electrical appliance is within the high-frequency impulse magnetic field, which is more convenient for charging.

### DESCRIPTION OF FIGURES

FIG. 1 is the overall structure view of the nondirectional induction coil;

FIG. 2 is the exploded view of the nondirectional induction coil;

FIG. 3 is the overall structure view of the radio frequency rechargeable dry cell;

FIG. 4 is the working principle diagram of the radio frequency rechargeable dry cell;

FIG. 5 is the exploded view of the radio frequency rechargeable dry cell.

### MODE OF CARRYING OUT THE INVENTION

Further explanation to the invention is stated below combining with the attached figures:

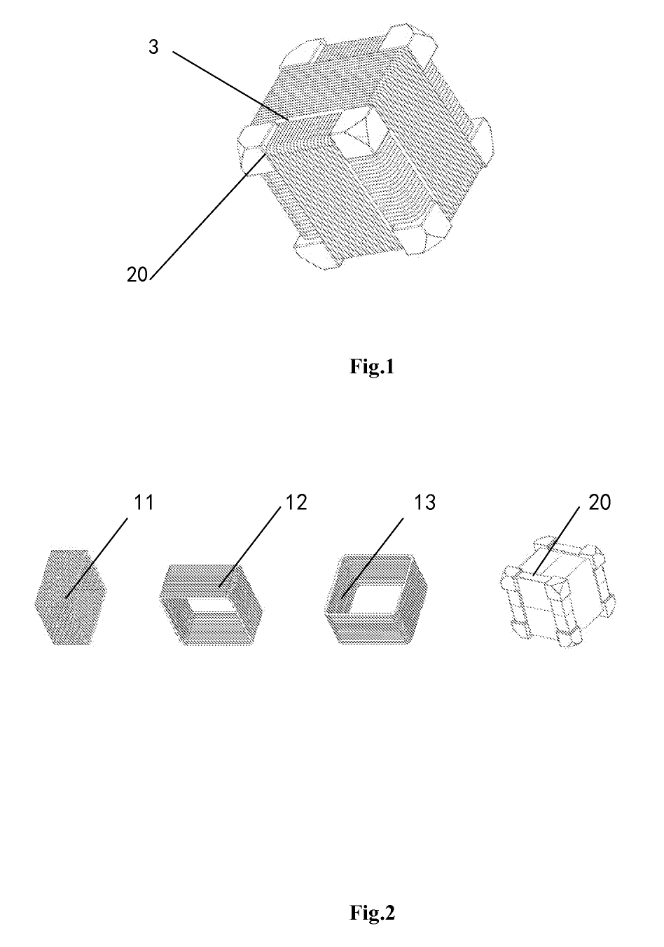

As shown in FIG. 1 and FIG. 2, the nondirectional induction coil 3, including X axis coil 11, Y axis coil 12, Z axis coil 13 and iron core 20; the X axis coil 11 is regularly move round the X axis of iron core 20; the Y axis coil 12 is regularly move round the Y axis of iron core 20; the Z axis coil 13 is regularly move round the X axis of iron core 20; the X axis coil 11, Y axis coil 12, Z axis coil 13 are installed in the iron core with 90 degree space included angle with each other, which make up the nondirectional induction coil 3.

When the nondirectional induction coil 3 is working, the X axis coil 11 induces the high-frequency impulse magnetic field from X axis and cut magnetic line to generate induced electric current in the coils;

The Y axis coil 12 induces the high-frequency impulse magnetic field from Y axis and cut magnetic line to generate induced electric current in the coils;

The Z axis coil 13 induces the high-frequency impulse magnetic field from Z axis and cut magnetic line to generate induced electric current in the coils.

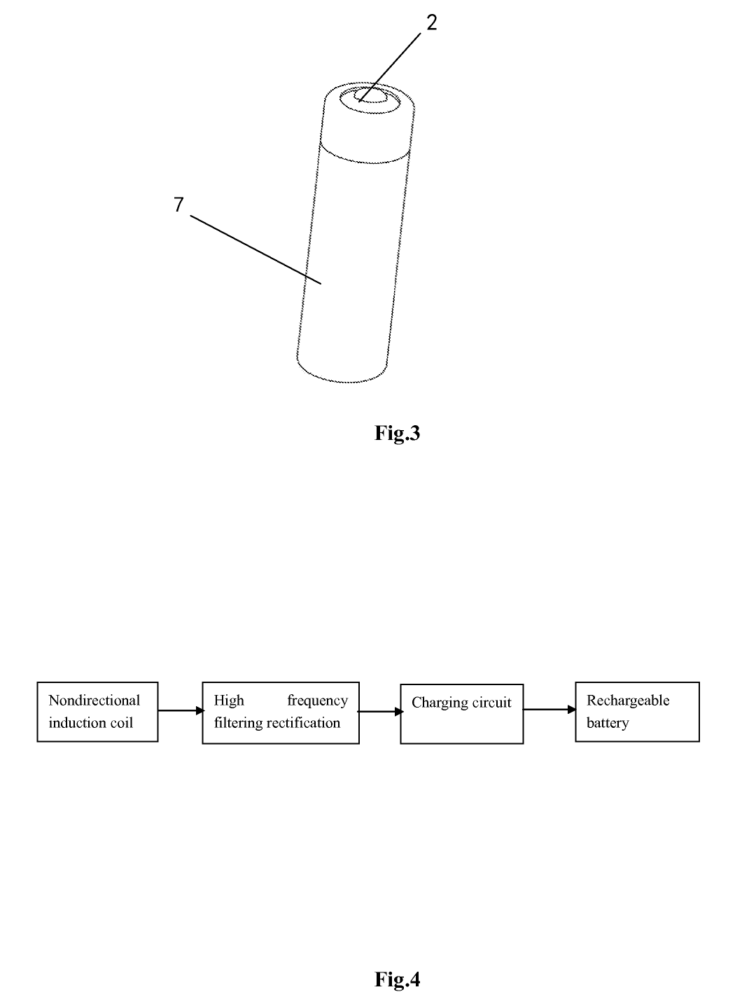

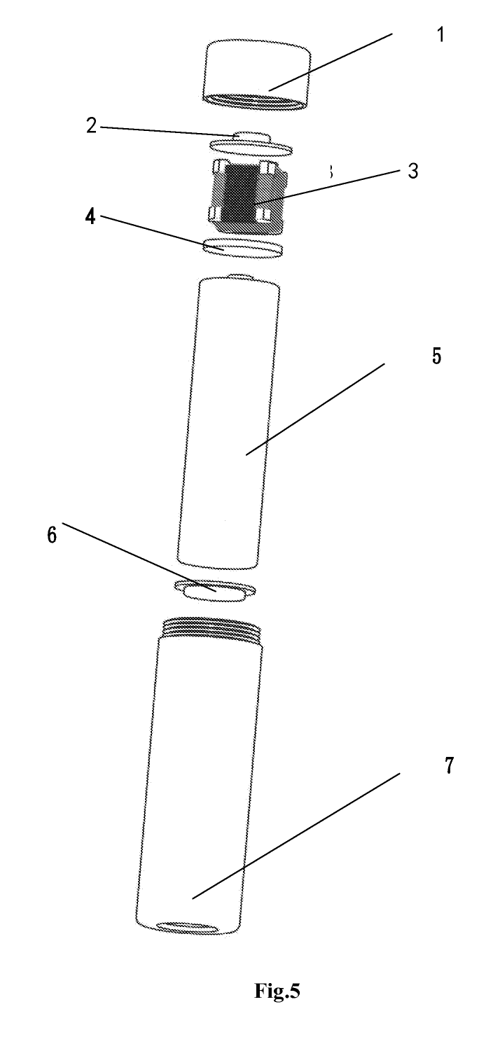

As show in FIG. 3, FIG. 4 and FIG. 5, the radio frequency rechargeable battery that composed by the nondirectional induction coil 3, including battery case 7, accumulator 5, upper cover 1, copperhead 2, sheet copper 6, nondirectional induction coil 3 and charging circuit 4, wherein the sheet copper 6 is installed in the bottom of the battery case 7 and come out of the battery case 7; inside the battery case 7 installs accumulator 5, nondirectional induction coil 3, charging control circuit 4 and copperhead 2 with electrical connection by sequence, and uses the upper cover 1 to install the rechargeable battery 5, charging control circuit 4, and nondirectional induction coil 3 inside the battery case 7, while the head of the copperhead 2 comes out of upper cover 1. When the radio frequency rechargeable battery is charging, the nondirectional induction coil will convert the pulsed electromagnetic wave into high frequency impulse current, while the high frequency rectification circuit and filter circuit will rectifying and filtering the high frequency impulse current from nondirectional induction coil, then it will be used for recharging the battery by the charging circuit; when the charging is completed, the charging circuit will cut out the charging current by judging, which ends the charging. Due to the radio frequency rechargeable battery, the charging could be realized once the electrical appliance is within the high-frequency impulse magnetic field, which is more convenient for charging.

1. A nondirectional radio frequency rechargeable dry cell, including a dry cell case and an accumulator that installed inside the dry cell case, characterized in that it also includes a nondirectional radio frequency charge unit, wherein the nondirectional radio frequency charge unit includes a nondirectional induction coil and charging control circuit, wherein the nondirectional induction coil connects with the accumulator by the charging control circuit; the nondirectional induction coil including:
X axis coil, wherein the coil is winding along with the X axial direction of iron core, to induce the high-frequency impulse magnetic field from X axis and cut magnetic line to generate induced electric current in the coils;
Y axis coil, wherein the coil is winding along with the Y axial direction of iron core, to induce the high-frequency impulse magnetic field from Y axis and cut magnetic line to generate induced electric current in the coils;
Z axis coil, wherein the coil is winding along with the Z axial direction of iron core, to induce the high-frequency impulse magnetic field from Z axis and cut magnetic line to generate induced electric current in the coils;
The iron core, wherein the iron core has construction filament winding of which includes X, Y, and Z axial direction spatial stereo coordinates.

2. A nondirectional radio frequency rechargeable dry cell as set forth in claim 1, characterized in that the dry cell case is composed by the upper cover and lower cover, wherein the upper cover and lower cover fixed joint by screw; the upward side of the upper cover has exerted copperhead, while the downward side of the lower cover has exerted sheet copper; between the copperhead and the sheet copper installs nondirectional induction coil, charging control circuit and accumulator with electrical connection by sequence.
